(19) United States
(12) Patent Application Publication
(10) Pub. No.: US 2026/0185632 A1
(43) Pub. Date: Jul. 2, 2026

(54) SAFETY VALVE CAP AND SAFETY VALVE

(71) Applicant: Smolsys AG, Root D4 (CH)

(72) Inventor: Patrick BURKHALTER, Heimiswil (CH)

(73) Assignee: Smolsys AG, Root D4 (CH)

(21) Appl. No.: 19/430,509

(22) Filed: Dec. 23, 2025

(30) Foreign Application Priority Data
Dec. 28, 2024 (EP) 24223577.8

(51) Int. Cl. F16K 35/02; F16K 35/10; F16K 51/02

(52) U.S. Cl. CPC F16K 35/027; F16K 35/10; F16K 51/02

(57) ABSTRACT

A safety valve cap for adjusting valves includes an inner sleeve and an outer sleeve, which are arranged concentrically one inside the other, wherein the two sleeves (10, 20) are axially movably arranged relative to each other in a defined lifting height (5), and can be bought from a pulled position into a pressed position by pressing or pulling the outer sleeve (20) toward the inner sleeve (10) and vice versa, wherein the inner sleeve (10) envelops a valve chamber (11) to be screwed onto a valve (40, 40’), and the outer sleeve (20) has a handle (21) for adjusting a valve (40, 40’) during use, and wherein both sleeves (10, 20) have an interlocking tooth system with teeth (6) and recesses (7), which are arranged axially limited in such a way as to only interlock in the pressed position, so that the sleeves (10, 20) are rotationally coupled, and wherein, in the pulled position, the outer sleeve (20) is decoupled from the inner sleeve (10), and can be freely rotated, wherein the outer sleeve (20) protrudes over the upper end of the inner sleeve (10) in the pulled position at least in the lifting height (5), and has a radial borehole (23) axially right above the upper end of the inner sleeve (10), into which a lock bolt or bracket can be passed in order to secure the valve setting, which mechanically prevents the sleeves from being pressed toward each other, so that no valve adjustment can take place. The invention also relates to a safety valve cap (1) with a valve (40, 40’), as well as to a safety valve (40’) with an additional sealing system (51).

### FIELD OF THE INVENTION

The invention relates to a safety valve cap for adjusting, closing and opening valves, in particular high-vacuum valves, as well as to a safety valve cap with a valve. The invention also relates to a safety valve.

### BACKGROUND

Valves are conventional components, and used to regulate and block the flow of fluids such as gases and liquids. Of interest here are valves that are actuated by hand on valve caps with handles, wherein the handles can also be configured as levers or handwheels. As a rule, they are interchangeably attached to the valves. They can be used to regulate the flow strength and/or close a line.

In safety-related applications, it can be important that unauthorized individuals be unable to adjust the valve caps. Typical applications for this purpose involve the flow of radioactive gases or biological or chemical hazardous substances. Releasing such media into the environment could have dangerous consequences for humans and the environment.

In order to prevent unauthorized access, for example, a bucket-shaped container could be placed over the entire valve with valve cap, and closed with a lock, thereby blocking access. However, if the valve ensures a vacuum or a high vacuum, the vacuum can be destroyed by very slightly turning the handwheel.

Other safety features could also be achieved by fixing a handwheel in place with a chain, which runs through the handwheel. As a result, the setting can now only be changed within a small range of angles. However, if the valve produces a vacuum or a high vacuum, a very small rotation of the handwheel is enough to destroy the vacuum.

### SUMMARY OF THE INVENTION

An object of the present invention is to describe a safety valve cap described at the outset, which prevents any valve adjustment by unauthorized individuals. This is intended to prevent sabotage through malicious manipulation as well as accidents resulting from an inadvertent change in the valve adjustment as much as possible. The cap is to be detachably connectable with a valve for maintenance and replacement purposes.

Another object of the invention is to make operation after unlocking easy and safe, or alternatively to increase safety to prevent an inadvertent valve adjustment even for authorized individuals.

Another invention relates to describing a safety valve cap with a valve as well as other embodiments with additional safety features. A valve with additional safety features is also to be described, so that it can be used with elevated safety in conjunction with hazardous substances.

The invention is achieved by the features in the respective claims in their categories, as well as by the claims dependent thereon.

The safety valve cap mentioned at the outset comprises an inner sleeve and an outer sleeve, which are arranged concentrically one inside the other, and coupled to each other by a retaining device, with respective axial upper and lower ends. The two sleeves are axially movably arranged relative to each other in a defined lifting height, and can be brought from a pulled position into a pressed position by pressing or pulling the outer sleeve toward the inner sleeve and vice versa.

The inner sleeve envelops a valve chamber, which is covered at the upper end by a lid, whose interior side has centrally arranged on it a point support for supporting a valve. In addition, it has a female thread at the lower end of the sleeve to be screwed onto a valve, so that a valve screwed into it can be closed with the inner sleeve completely screwed on. The valve placed therein is correspondingly reopened by turning in the opposite direction.

The outer sleeve has a handle for adjusting, closing and opening a valve during use. It preferably also comprises a cover at its upper end.

Both sleeves have an interlocking tooth system, with teeth and recesses, which are arranged axially limited in such a way as to only interlock in the pressed position. In this pressed position, the sleeves are rotationally coupled, so that turning the handle on the outer sleeve causes the inner sleeve to also turn, and adjusts an inserted valve.

In the pulled position, the outer sleeve is decoupled from the inner sleeve, and can be freely rotated without turning the inner sleeve, so that the valve setting can only be changed with the handle in the pressed position during use.

According to the invention, the outer sleeve protrudes over the upper end of the inner sleeve in the pulled position at least in the lifting height, and has a through or half-side radial borehole axially right above the upper end of the inner sleeve. In order to secure the valve setting, a lock bolt or bracket can be passed through or into this borehole, and when inserted or retracted, mechanically prevents the sleeves from being pressed toward each other, because the bolt or bracket is located over the inner sleeve. As a consequence, turning the handle only results in a free rotation of the outer sleeve. In this state, no valve adjustment can take place.

For example, a bracket of a padlock can be used given a through borehole. In the event of a one-sided borehole, a bolt lock with an extendable bolt can be used, as known for sliding doors and window locks. In this embodiment, the one-sided borehole can lead through the handle, so that more overall length can be used for the bolt lock. The safety valve cap can comprise a suitable lock, in particular a bolt lock.

Since the safety valve cap according to the invention can be or is comfortably provided with a lock, sabotage or inadvertent adjustment by an unauthorized individual can be prevented by locking. After the lock has been opened and the bolt over the inner sleeve has been removed, the two sleeves can be tightly coupled by pressing the handle, thereby making it possible to adjust the valve setting.

In particular, the invention also relates to a safety valve cap with a valve screwed therein, which can be operated with the safety valve cap.

The invention also relates to a safety valve, which can be used together with the described safety valve cap or is built into the latter. It comprises a valve housing and a valve stem that coaxially traverses it and is mounted so that it can axially move relative thereto, wherein a bellows seal is arranged in between. The latter is welded to the valve housing below and to the valve stem above or vice versa. According to the invention, an additional sealing system is arranged between the valve stem and the valve housing, which comprises at least one first O-ring between the valve stem and the valve housing. As a result, the additional sealing system offers extra protection during use given a failure of the bellows seal.

Additional advantageous embodiments are described in the dependent claims. The invention will be described in more detail in conjunction with the figures.

### BRIEF DESCRIPTION OF THE DRAWINGS

The invention will be illustrated in various drawings below, and explained in more detail with the help of the reference numbers defined later. Shown on:

FIGS. 1A-1D are sectional views of a safety valve cap according to the invention in a first variant, with FIG. 1A showing the pulled position; FIG. 1B showing the pressed position; FIG. 1C showing a sectional view according to FIG. 1A; and FIG. 1D showing a perspective view according to FIG. 1A;

FIGS. 2A-2D are sectional view of a safety valve cap according to the invention in a second variant, with FIG. 2A showing the pulled position; FIG. 2B showing the pressed position; FIG. 2C showing a sectional view according to FIG. 2A; and FIG. 2D showing a perspective view according to FIG. 2B;

FIGS. 3A-3C are sectional view of a safety valve cap according to the invention in a third variant, with FIG. 3A showing the pulled position; FIG. 3B showing the pressed position; and FIG. 3C showing a sectional view according to FIG. 3A;

FIG. 4 is a perspective side view of a complete valve with safety valve cap and a bolt lock secured therein;

FIGS. 5A and 5B are sectional views of a complete safety valve, with safety valve cap according to the invention, with FIG. 5A showing transverse to the line and to the handle; and FIG. 5B showing in the plane of the line and the handle; and

FIG. 6A and 6B are schematic, sectional views of the most important components of a safety valve according to the invention, with FIG. 6A showing a simplified embodiment and FIG. 6B showing a preferred embodiment.

### WAYS OF IMPLEMENTING THE INVENTION

In all figures, the terms “above” 2 and “below” 3 refer to the orientation shown here.

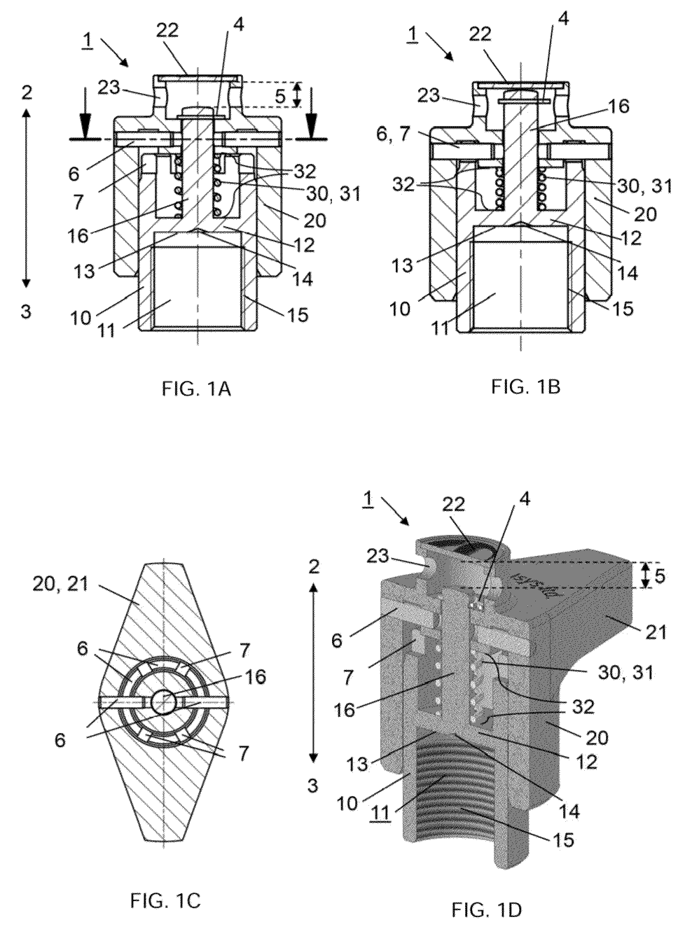

FIGS. 1 to 3 show different variants of a safety valve cap 1 according to the invention. They are all suitable for adjusting, closing and opening valves 40, 40’, in particular high vacuum valves.

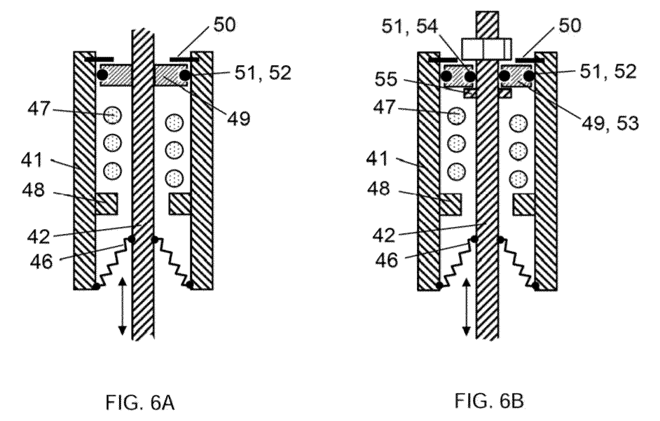

On the two FIGS. 5A and 5B, a safety valve cap 1 according to FIG. 1 on a valve 40, 40’ is screwed onto a valve housing 41 with a valve stem 42 protruding therefrom, so that the valve stem 42 is flush with the safety valve cap 1. While continuing to twist the safety valve cap 1 onto the valve housing 41, the valve stem 42, which is spring-loaded and mounted in the valve housing 41, is pressed down, as a result of which a sealing surface 43 at the lower end of the valve stem 42 diminishes a flow cross section of a flow line 45, and is finally pressed onto a seat 44, so as to prevent a flow. The valve 40, 40’ is then closed. When turning the safety valve cap 1 in the opposite direction, the spring-loaded valve stem 42 is lifted again, and the valve 40, 40’ is thereby opened.

The safety valve caps 1 according to FIGS. 1-3 will be described in more detail below.

Each safety valve cap 1 comprises an inner sleeve 10 and an outer sleeve 20, which are concentrically arranged one inside the other and coupled to each other by a retaining device 4, for example a snap ring, with respective axially upper ends 2 and lower ends 3. The two sleeves 10, 20 are arranged so that they can axially move relative to each other in a defined lifting height 5, and can be moved from a pulled position according to FIGS. 1A, 2A, 3A into a pressed position according to FIGS. 1B, 2B, 3B and vice versa by pressing or pulling the outer sleeve 20 to the inner sleeve 10.

The inner sleeve 10 envelops a valve chamber 11, which is covered with a lid 12 at the upper end, the interior side 13 of which has centrally arranged on it a point support 14 for supporting a valve 40, 40’. The inner sleeve 10 additionally comprises a female thread 15 at the lower end to be screwed onto the valve 40, 40’, so that a valve 40, 40’ screwed into the latter can be closed with the inner sleeve 10 completely screwed on. The lid 12 can additionally extend upward to a guide bolt 16, as a result of which the upper end of the inner sleeve 10 is elevated accordingly.

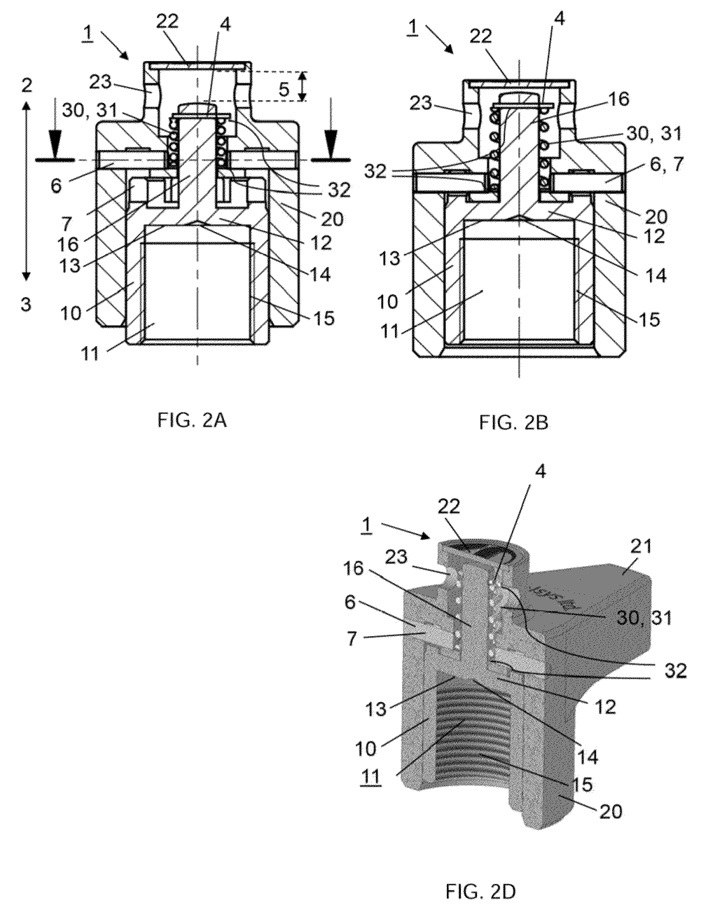

The outer sleeve 20 has a handle 21, see FIGS. 1C, 1D, 2D, for adjusting, closing and opening a valve 40, 40’ during use, and preferably also a cover 22 at its upper end.

Both sleeves 10, 20 have an interlocking tooth system with teeth 6 and recesses 7, which are axially limited in such a way as to only interlock in the pressed position. In the pressed position, the sleeves 10, 20 are thus rotationally coupled. Turning the handle 21 on the outer sleeve 20 causes the inner sleeve 10 to also turn, and adjusts an inserted valve 40, 40’. The tooth system will be explained in more detail later.

In the pulled position, the outer sleeve 20 can be decoupled from the inner sleeve 10 and freely rotated without turning the inner sleeve 10. Therefore, the valve setting can only be changed with the handle 21 in the pressed position during use.

The outer sleeve 20 protrudes over the upper end of the inner sleeve 10 in the pulled position at least in the lifting height 5, and has a through or half-side borehole 23 axially right above the upper end of the inner sleeve 10, through or into which a lock bolt or bracket (not shown) can be passed to secure the valve setting. As soon as a bolt or bracket (not shown) has been inserted, it mechanically prevents the sleeves from being pressed toward each other, because it is supported on the upper end 2 of the inner sleeve 10. As a consequence, turning the handle 21 only results in a free rotation of the outer sleeve 10, so that no valve adjustment can take place.

The lifting height 5 is preferably at least as wide as the diameter of the borehole 23, and a safety margin is on the order of half a diameter thereof, so as to prevent a breakthrough of the borehole 23.

For example, a padlock shackle can be used given a through borehole 23 of the kind shown on FIG. 1-3 and 5.

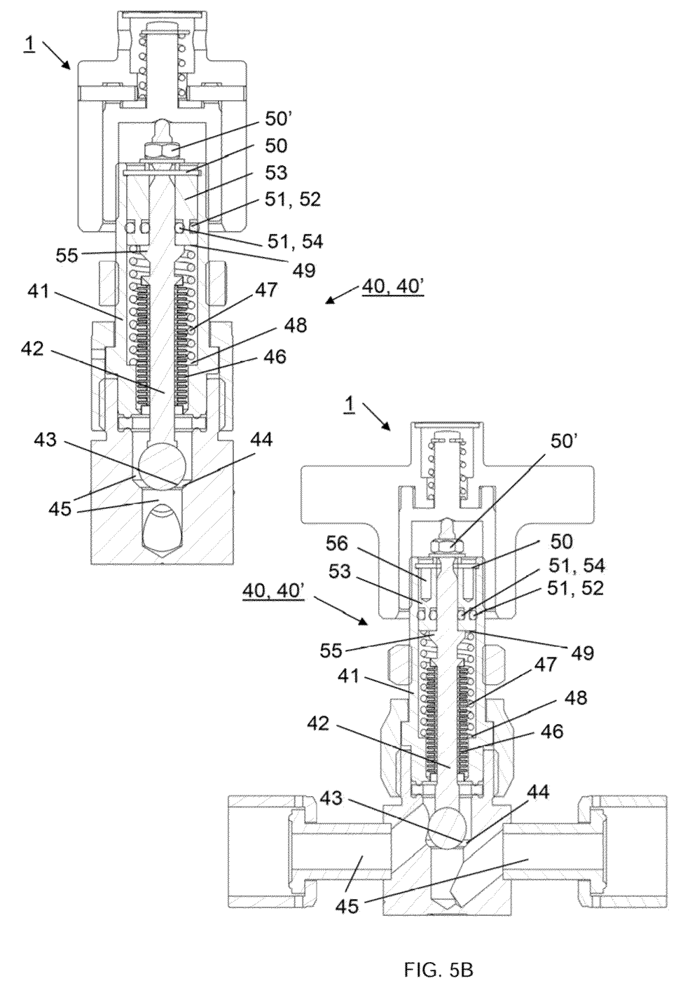

FIG. 4 shows an example for a view of a safety valve cap 1 according to the invention on a valve 40, 40’, in which the handle 21 reaches up to the upper end of the outer sleeve 20. This safety valve cap 1 has a one-sided radial borehole 23, which runs through the handle 21. A bolt lock 8 of the kind known for sliding door or window locks is inserted into this borehole 23. In this embodiment, the one-sided borehole 23 can be guided through the handle 21, so that more overall length can be used for the bolt lock 8. The safety valve cap 1 can contain a suitable lock, in particular a bolt lock 8.

The interlocking tooth system with teeth 6 and recesses 7 is visible on FIGS. 1C, 2C, 3C as well as FIGS. 1D and 2D. Each tooth 6 of a sleeve 10, 20 has a recess 7 in the other sleeve 20, 10 lying opposite in a suitable rotational position to each other. When pushed together, at least one tooth 6 of one sleeve 10, 20 is enveloped in the circumferential direction on both sides by teeth 6 of the other sleeve 20, 10, resulting in a rotational coupling. In the embodiments shown here, two pins are driven as teeth 6 radially in the direction of the axis in the outer sleeve 20. In the inner sleeve 10, the edge in this embodiment has six essentially bent rectangular teeth 6 on the periphery spaced uniformly apart from each other, the six interstitial spaces of which form the recesses 7 into which the pins can be inserted as teeth 6. Accordingly, a tooth system can be generated at a respective distance of 60° by inserting the pins as teeth 6 into two opposing recesses 7. In this embodiment, the tooth system in the outer sleeve 20 thus consists of two teeth 6 configured as two pins and two large recesses that make up the remaining circumference. There are many other variants of tooth systems.

Pulling and pressing the handle 21 makes it easy to switch back and forth between the pressed, coupled position into the pulled, decoupled position of the safety valve cap.

Preferably provided in the safety valve cap 1 according to FIGS. 1-3 is a safety device 30, which can be used to secure at least one of the positions, preferably both positions. Consequently, three variants of this safety device 30 are described.

The first two variants of this safety device are shown on FIGS. 1 and 2. The safety device 30 is arranged between the sleeves 10, 20 as an axially loadable locking spring 31 with an upper and a lower end, wherein each of the ends is supported on the heel 32 of another sleeve 20, 10. As a result, the locking spring 31 is tensioned in one of the positions, and released in the other.

In the variant according to FIG. 1, the locking spring 31 is released in the pulled position according to FIGS. 1A and 1D, so that the safety valve cap 1 remains in this decoupled position as long as the handle 21 is not pressed. As a consequence, a built-in valve 40, 40’ cannot be inadvertently adjusted. This safe version is desired in particular if inadvertently adjusting the valve 40, 40’ poses a risk to humans or the environment, or to an ongoing process that is regulated with the valve 40, 40’.

In the variant according to FIG. 2, the locking spring 31 is released in the pressed position according to FIGS. 2B and 2D, so that the safety valve cap 1 remains in this rotationally coupled position as long as the handle 21 is not pulled. In this version, a built-in valve 40, 40’ can always be adjusted. The user can make the adjustment at any time, and does not have to first press on the handle 21. The comfort level is high, but there is no additional safety after the lock has been removed or the bolt lock 8 has been opened.

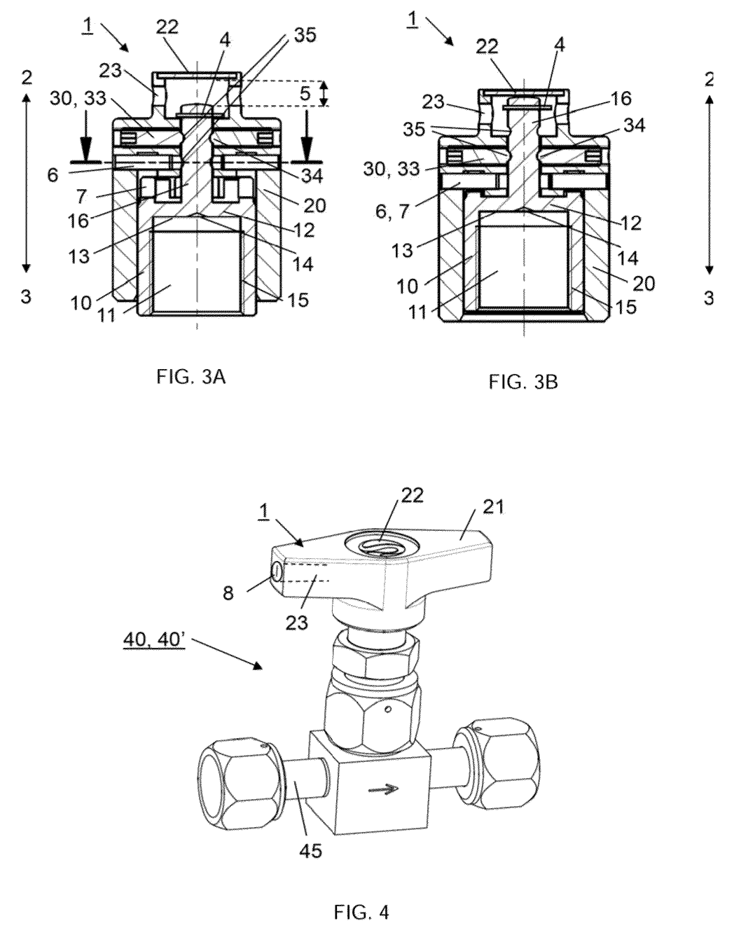

In a variant according to FIG. 3, the safety device 30 is configured as at least one threaded pin 33, which is radially introduced into the outer sleeve 20 and on the inner sleeve 10 and engages into one or preferably two appropriately positioned circumferential grooves 35. FIG. 3 shows two such threaded pins 33. The grooves 35 are positioned in such a way that the threaded pin 33 can engage into a groove 35 in each of the positions, so as to fix the respective position according to FIGS. 3a or 3b.

Even if the lock has been removed or the bolt lock 8 is opened, the user thus still requires a tool in order to achieve the coupled, pressed position.

The threaded pin 33 is alternatively equipped with a spring-loaded pressure ball 34, so as to achieve a change and latching into one or both grooves 35 without using a tool. This makes it easy to switch between the two positions. As soon as a built-in valve 40, 40’ has been adjusted, a switch can be made into the pulled position. This temporarily provides for safety until the lock can be inserted again or the bolt lock 8 is extended.

The safety device 30 in the different variants can be arranged either in the area radially outside of the valve chamber 11 (not shown) or radially outside of a guide bolt 16 that extends upwardly on the lid of the inner sleeve, as respectively shown here.

A snap ring can here be used as the retaining device 4, as respectively shown here. There are numerous alternative embodiments, for example a nut.

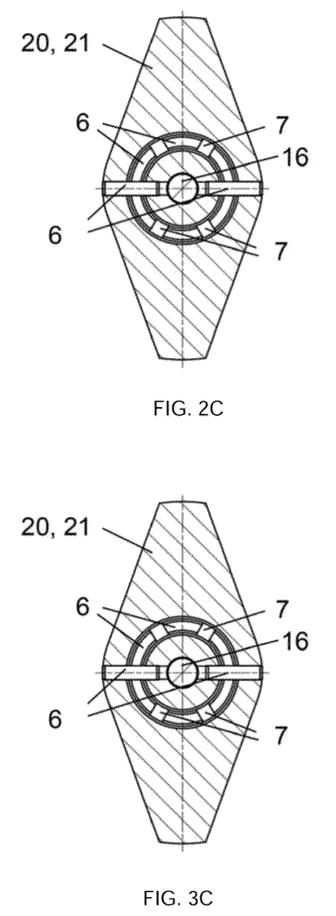

A conventional valve 40 can be used as the valve 40, 40’. If required by the application to increase safety, a safety valve 40’ according to the invention of the kind shown on FIGS. 5A and 5B and schematically on FIGS. 6A and 6B can be placed in the safety valve cap 1. It comprises a valve housing 41 and a valve stem 42 that coaxially traverses it, and is mounted so that it can axially move relative thereto, wherein a bellows seal 46 is arranged in between and welded to the valve housing 41 below and to the valve stem 42 above, or vice versa. An additional sealing system 51 is arranged between the valve stem 42 and the valve housing 41. It comprises at least one first O-ring 52 between the valve stem 42 and the valve housing 41, so that the additional sealing system 51 can offer extra protection during use given a failure of the bellows seal 46. This version is shown on FIG. 6A.

An improved variant is shown on FIG. 6B as well as on FIG. 5. In this safety valve 40’, a cylindrical piston 53 is axially movably inserted between the valve stem 42 and the valve housing 41. The first O-ring 52 of the sealing system 51 is inserted between the piston 53 and the valve housing 41. The sealing system 51 here comprises a second O-ring 54, which is inserted between the valve stem 42 and the piston 53.

It is preferred for both variants according to FIG. 6A and 6B that the valve stem 42 be mounted in the valve housing 41 spring loaded by a valve spring 47. The valve spring 47 is here supported below on a first heel 48 on the valve housing 41 and above on a second heel 49, which itself is upwardly limited in its movement by a first, preferably removable locking mechanism 50 on the valve housing 41. The second heel 49 is either securely connected with the valve stem 42 according to FIG. 6A, or mounted so that it can move around the valve stem 42 like a cylindrical piston 53 and supported above on the valve stem 42 with a second, preferably removable locking mechanism 50’ according to FIG. 6B.

The advantage to the embodiment according to FIG. 6B is that the safety valve 40’ can be opened for maintenance purposes. After removing the second locking mechanism 50’ on the valve stem 42, for example the nut, and the first locking mechanism 50 on the valve housing 41, or example the snap ring, the cylindrical piston 53 with its two O-rings 52, 54 of the sealing system 51 incorporated therein and the valve springs 47 can be removed. The removed parts can subsequently be tested and cleaned or replaced. An additional stop 55 on the valve stem during renewed assembly ensures that the second locking mechanism 50’, or example the nut, can be tightened up to this stop 55, so as to reach the provided position of the piston 53 in the axial height. In addition, the piston 53 can have one or two boreholes 56, see FIG. 5B, so as to enable access there when pulling the piston 53 out of the valve housing 41.

If allowed by the application, a conventional valve 40 can be used instead of a safety valve 40’. Using a safety valve 40’ is advantageous in particular when the goal is to regulate or block the flow of hazardous substances with it.

According to the invention, a safety valve cap 1 can have screwed into it a valve 40, 40’, which can be operated with the safety valve cap 1. The used valve 40, 40’ can in particular be a gas valve, preferably a vacuum valve or a high vacuum valve. Such a safety valve cap 1 with a valve 40, 40’ is suitable for use in the high-security area, even if the fluids to be used contain dangerous hazardous substances, for example biological, chemical or radioactive hazardous substances.

### Reference List

1 Safety valve cap

2 Upper end

3 Lower end

4 Retaining device, snap ring

5 Lifting height

6 Tooth

7 Recess

8 Bolt lock

10 Inner sleeve

11 Valve chamber

12 Lid

13 Interior side

14 Point support

15 Female thread

16 Guide bolt

20 Outer sleeve

21 Handle

22 Cover

23 Radial borehole, through or one-sided

30 Safety device

31 Locking spring

32 Heel

33 Threaded pin

34 Spring-loaded pressure ball

35 Circumferential groove

40 Valve; 40’ safety valve, valve

41 Valve housing

42 Valve stem

43 Sealing surface on the valve stem

44 Seat

45 Flow line

46 Bellows seal

47 Valve spring

48 First heel on the valve housing

49 Second heel

50 First locking mechanism on the valve housing, snap ring

50’ Second locking mechanism on the valve stem, nut

51 Sealing system, additional

52 First O-ring

53 Cylindrical piston

54 Second O-ring

55 Stop

56 Borehole

1. A safety valve cap for adjusting, closing and opening valves, the safety valve cap comprising:
an inner sleeve and an outer sleeve, which are arranged concentrically one inside the other and coupled to each other by a retaining device, with respective axial upper ends and lower ends,
wherein the two sleeves are axially movably arranged relative to each other in a defined lifting height, and can be brought from a pulled position into a pressed position by pressing or pulling the outer sleeve toward the inner sleeve and vice versa,
wherein the inner sleeve envelops a valve chamber, which is covered at the upper end by a lid, whose interior side has centrally arranged on it a point support for supporting a valve, as well as a female thread at the lower end of the inner sleeve to be screwed onto a valve, so that a valve screwed into the female thread can be closed with the inner sleeve completely screwed on, and wherein the outer sleeve has a handle for adjusting, closing and opening a valve during use, and also a cover at an upper end, and wherein both sleeves have an interlocking tooth system with teeth and recesses, which are arranged axially limited in such a way as to only interlock in the pressed position, so that in the pressed position, the sleeves are rotationally coupled, and turning the handle on the outer sleeve causes the inner sleeve to also turn, and an inserted valve is adjusted, and wherein, in the pulled position, the outer sleeve is decoupled from the inner sleeve, and can be freely rotated without turning the inner sleeve, so that the valve setting can only be changed with the handle in the pressed position during use,
wherein the outer sleeve protrudes over the upper end of the inner sleeve in the pulled position at least in the lifting height, and has a through or half-side radial borehole axially right above the upper end of the inner sleeve, through or into which a lock bolt or bracket can be passed in order to secure the valve setting, which when located over the inner sleeve mechanically prevents the sleeves from being pressed toward each other, so that turning the handle only results in a free rotation of the outer sleeve, and no valve adjustment can take place.

2. The safety valve cap according to claim 1, wherein a safety device is provided, which can be used to secure at least one of the positions.

3. The safety valve cap according to claim 2, wherein an axially loadable locking spring with an upper and a lower end is arranged between the sleeves as a safety device, wherein each of the ends is supported on a heel of another sleeve, so that the locking spring is tensioned in one of the positions, and released in the other.

4. The safety valve cap according to claim 3, wherein the locking spring is released in the pulled position, so that the safety valve cap remains in the decoupled position as long as the handle is not pressed, so that the valve cannot be inadvertently adjusted.

5. The safety valve cap according to claim 3, wherein the locking spring is released in the pressed position, so that the safety valve cap remains in the rotationally coupled position as long as the handle is not pulled, so that the valve can always be adjusted.

6. The safety valve cap according to claim 2, wherein the safety device is reached with a threaded pin, which is radially introduced into the outer sleeve, wherein the inner sleeve has secured to the inner sleeve one or two matching, circumferential grooves, into which the threaded pin can engage in at least one of the positions, so as to fix the respective position.

7. The safety valve cap according to claim 6, wherein the threaded pin is equipped with a spring-loaded pressure ball, so as to achieve a change and latching into one or both grooves without using any tools.

8. The safety valve cap according to claim 2, wherein the safety device is arranged either in the area radially outside of the valve chamber or radially outside of a guide bolt that extends upwardly on the lid of the inner sleeve.

9. The safety valve cap according to claim 1, wherein a bolt lock is placed in the at least half-side radial borehole, from which a bolt can be extended over the inner sleeve while closing, wherein the bolt mechanically prevents the sleeves from being pressed toward each other.

10. A safety valve for use with the safety valve cap according to claim 1, the safety valve comprising:
a valve housing and a valve stem that coaxially traverses the valve housing and is mounted so that the valve stem can axially move relative thereto,
wherein a bellows seal is arranged in between, and welded to the valve housing below and to the valve stem above or vice versa,
wherein an additional sealing system is arranged between the valve stem and the valve housing, which comprises at least one first O-ring between the valve stem and the valve housing, so that the additional sealing system offers extra protection during use given a failure of the bellows seal.

11. The safety valve according to claim 10, wherein a cylindrical piston is axially movably inserted between the valve stem and the valve housing, wherein the first O-ring is inserted between the piston and the valve housing, and the sealing system comprises a second O-ring, which is inserted between the valve stem and the piston.

12. The safety valve according to claim 10, wherein the valve stem is mounted in the valve housing spring loaded by a valve spring, wherein the valve spring is supported below on a first heel on the valve housing and above on a second heel, which itself is upwardly limited in its movement by a first locking mechanism on the valve housing, wherein the second heel is either securely connected with the valve stem, or mounted so that it can move around the valve stem like a cylindrical piston, and supported above on the valve stem with a second locking mechanism.

13. The safety valve according to claim 1, wherein a lockable valve is built into the valve chamber.

14. The safety valve according to claim 13, wherein the lockable valve is a vacuum or a high vacuum valve.

15. The safety valve according to claim 13, wherein the safety valve is usable in a high security area, and wherein the fluids to be used can contain biological, chemical or radioactive hazardous substances.
